(19) United States
(12) Patent Application Publication
(10) Pub. No.: US 2006/0176497 A1
(43) Pub. Date: Aug. 10, 2006

(54) Control device for printing digital image and printer incorporating the same

(75) Inventors: Masahiro Kimura, Fukuoka-ken (JP); Yoshihiro Hamaguchi, Fukuoka-ken (JP); Claudine Wolas, Long Beach, CA (US)

Correspondence Address: EDWARDS & ANGELL, LLP, P.O. BOX 55874, BOSTON, MA, 02205, US

(73) Assignee: Seiko Epson Corporation

(21) Appl. No.: 11/054,920

(22) Filed: Feb. 9, 2005

(51) Int. Cl. G06F 3/12

(52) U.S. Cl. 358/1.13; 358/1.15

(57) ABSTRACT

An operation of a user is inputted to an operating section. A display shows information to the user. A controller causes, in accordance with the operation inputted to the operating section, the display to selectively show: a first screen image showing a plurality of groups, each of which includes at least one digital image stored in a storage medium and categorized in accordance with a predetermined condition, so that the user designates at least one of the groups through the operating section; and a second screen image showing, in a substantial full-screen manner, the at least one digital image included in the at least one of the groups designated by the user, so that the user browses the at least one digital image one by one to specify the number of sheets to be printed with respect to at least one browsed digital image, through the operating section. The controller is operable to cause a printer to execute a printing operation in accordance with the specification performed in the second screen image when a print instruction is inputted to the operating section.

### BACKGROUND OF THE INVENTION

The present invention relates to a control device for printing a digital image which has a GUI function and which includes an operating section to which a user inputs an operation, and a display section for graphically displaying information to the user; and to a printer including the same.

There have already been known so-called direct printing techniques, wherein a digital image processor, such as a digital still camera (DSC), is directly connected to a recording device, such as an inkjet printer, thereby performing recording (printing) on a recording medium (recording paper) on the basis of a digital image file transmitted from the DSC, or wherein a digital image file in a memory card is directly readout by way of a memory card slot of a recording device, thereby performing printing on a recording medium. In view of a convenience of having the ability to perform printing of a digital photo can be performed without use of an information processor, such as a personal computer, electronic devices, such as an inkjet printer and a DSC, which can employ the direct printing technique are coming into widespread use.

When printing of digital images is performed by connecting a digital image processor, such as a DSC, to a recording device, the following configuration is generally employed: a list of simplified images, such as thumbnail images, displayed on a display section of the digital image processor is browsed through operation on an operating section of the digital image processor (see, e.g., Japanese Patent Publication No. 2004-255740A); and desired images are selected and designated therefrom, whereupon an instruction for printing is provided. In addition, when printing of a digital image is performed with use of an independent recording device and by directly reading the digital image files in a memory card inserted in a memory card slot, an operating section of the recording device is operated, whereby a list (an index image) of thumbnail images displayed on a display section of the recording device is browsed; and desired images are selected and designated therefrom, whereupon an instruction for printing is provided (see, e.g., Japanese Patent Publication No. 2002-154243A).

However, the simplified images, such as thumbnail images, are generally significantly reduced in size and significantly low in resolution as compared with actual digital images (original images). Therefore, even when an actual digital image (original image) is, for instance, out of focus, blurred due to camera motion, or the like, in many cases discrimination of such an image by viewing the thumbnail images encounters difficulty. More specifically, a level of picture quality of the actual digital image cannot be known until the image is actually printed. As a result, a user notices a defect having occurred at the time of photographing (being out-of-focus, being blurred due to camera motion, or the like) only after seeing a printed result after printing; accordingly, the printing may result in wasteful printing.

### SUMMARY OF THE INVENTION

It is therefore an object of the invention to enhance usability in selection of desired digital images and in recording (printing) of the thus-selected digital images with use of a recording device, and also to reduce probability of wasteful printing, such as recording (printing) performed without awareness of a defect having occurred at the time of photographing.

In order to achieve the above object, according to the invention, there is provided a control device for printing a digital image, comprising:

an operating section, to which an operation of a user is inputted;

a display, which shows information to the user; and

a controller, which causes, in accordance with the operation inputted to the operating section, the display to selectively show:

a first screen image, operable to show a plurality of groups, each of which includes at least one digital image stored in a storage medium and categorized in accordance with a predetermined condition, so that the user designates at least one of the groups through the operating section; and

a second screen image, which shows, in a substantial full-screen manner, the at least one digital image included in the at least one of the groups designated by the user, so that the user browses the at least one digital image one by one to specify the number of sheets to be printed with respect to at least one browsed digital image, through the operating section,

the controller operable to cause a printer to execute a printing operation in accordance with the specification performed in the second screen image when a print instruction is inputted to the operating section.

When a user selects digital images to be recorded in a recording medium among a large number of digital images stored in a storage medium, such as a nonvolatile memory card, first, the digital images in the storage medium are grouped in accordance with a predetermined condition, and displayed in a form of a list on the display. In the first screen image, the user selects and designates one or more groups which are assumed to include desired digital images on the basis of the predetermined condition of grouping, and the like, and causes the display to display the second screen image. As a result, a large number of digital images can be narrowed down through selection on a per-group basis.

In addition, digital images within the group having been selected and designated by the user in the first screen image are sequentially browsed one by one in substantially full-screen display, thereby enabling a search for desired digital images. Accordingly, usability in selection of desired digital images can be enhanced.

In addition, when the desired digital image involves a defect having occurred at the time of photographing, such as being out of focus, blurred due to camera motion, or the like, the user can grasp the failure easily and without fail, and determine whether or not to perform printing on the recording medium. Accordingly, probability of wasteful printing, such as recording (printing) performed without awareness of a defect having occurred at the time of photographing, can be reduced.

Here, it is preferable that the controller is operable to cause the printer to execute a predetermined number of printing operation for each of the at least one digital image in the at least one group designated by the user, in a case where the print instruction is inputted when the first screen image is shown in the display.

According to this configuration, when the instruction for printing is provided in a situation where the first screen image is currently displayed, printing of all the digital images in the designated groups is effected. Therefore, the user can perform printing of desired digital images to a recording medium on a per-group basis. At this time, when a plurality of date groups are designated, all the digital images in the plurality of date groups can be printed by a single instruction for printing.

It is also preferable that: the first screen image includes a cursor which designates one of the groups; and the controller is operable to cause the printer to execute a predetermined number of printing operation for each of the at least one digital image in the group designated by the cursor, in a case where the print instruction is inputted when the first screen image is shown in the display, and no group is designated by the user through the operating section.

According to this configuration, when an instruction for printing is provided in a situation where the first screen image is currently displayed, and none of the groups is designated by way of the operating section, printing of all the digital images in the group currently being designated by the cursor is effected. Therefore, the user can perform printing of each group by repeating intuitive operations, such as providing an instruction for directly performing printing while skipping an operation procedure of designating a group.

It is also preferable that each of the groups is shown with a thumbnail of one digital image included therein.

According to this configuration, a user can easily identify contents of the digital images in the group while viewing the reduced image attached to each of the groups.

Here, it is further preferable that the one digital image is the latest one in each of the groups.

In many cases, the latest digital image among digital images photographed by a user himself/herself is considered to remain in the user's memory most clearly. Accordingly, the latest digital image within the group is taken as the reduced image. As a result, the user can easily identify contents of digital images in the group.

Preferably, each of the groups is shown with a total number of the at least one digital image included therein.

In this case, appropriate operation in accordance with the number of the digital images in the group is enabled. For instance, in a case where the number of digital images in the group is small and contents thereof can be grasped without browsing the digital images in the group on the second screen image, an instruction for printing can be provided directly from the first screen image. Meanwhile, in a case where the number of digital images in the group is extremely large, when printing is performed on a per-group basis, a large amount of unnecessary digital images may be recorded; therefore, printing is preferably performed by designating only necessary digital images while digital images in the group on the second screen are browsed. More specifically, a user can eliminate unnecessary operation and wasteful recording in accordance the number of digital images in the group, thereby performing effective recording of digital images to a recording medium.

Preferably, the browsed digital image is shown with a name of the designated group which includes the browsed digital image.

In this case, operations of browsing, selection, and designation can be performed while grasping the group which includes a digital image which is currently displayed on the second screen display. As a result, there is also enabled such a feature that, for instance, even when a condition where a digital image is generated, or the like, cannot be determined from only a content of the digital image, the condition can be determined in relation to the group to which the digital image belongs.

Preferably, the browsed digital image is shown with a printing condition to be effected with respect to the browsed digital image.

In this case, setting for the print-condition (setting of a type of the recording medium and size of the same, setting of marginless printing, and the like) can be confirmed on the second screen without switching the display screen on the display to the print-condition setting screen, or the like; and, in addition, a print result can be imagined while viewing the digital image on the basis of the print-condition setting, thereby further enhancing usability.

Preferably, each of the groups is shown with information indicating whether at least one digital image included therein has been printed at least once.

It is also preferable that the browsed digital image is shown with information indicating whether the browsed digital image has been printed at least once.

According to the above configuration, by facilitating the user's grasping of previously printed digital image files, wasteful recording resulting from unintentional, repetitive recording of a digital image having already been printed on a recording medium can be prevented. In addition, when a configuration which allows printing of an previously printed digital image is employed, needs for extra printing, or the like, can also be satisfied. Meanwhile, indication of whether or not printing has already been performed may be displayed by: print-history data or the like are written in a recording medium in advance; and, upon reference to the history data, an indication of already having been printed is displayed in conjunction with the first screen or the second screen.

Preferably, the predetermined condition is a date of which the at least one digital image is generated.

With regard to digital image files photographed by a user himself/herself, in many cases, the user can easily identify what kind of digital image files are included in the group on the basis of a date of photographing. Therefore, by grouping digital images stored in a recording medium in accordance with dates on which the digital images have been generated (for instance, dates of photographing), identification of desired digital images by the user is facilitated.

According to the invention, there is also provided a printer incorporating the above control device, comprising a printing mechanism which is caused to execute the printing operation by the controller of the control device.

### BRIEF DESCRIPTION OF THE DRAWINGS

In the accompanied drawings:

FIG. 1 is an external perspective view of an inkjet recording apparatus according to an embodiment of the invention;

FIG. 2 is a view showing a date-selection screen of a digital image recording control device in the inkjet recording apparatus;

FIG. 3 is a view showing a photo-selection screen of the digital image recording control device;

FIG. 4 is a view showing a print confirmation screen of the digital image recording control device;

FIG. 5 is a view showing an information screen of the digital image recording control device;

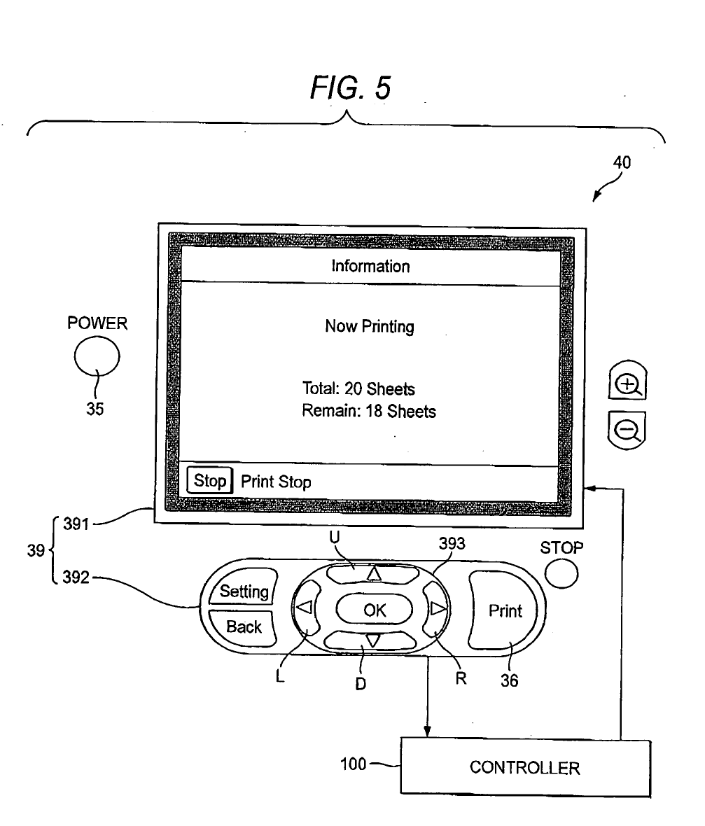

FIG. 6 is a view showing a date-selection screen of the digital image recording control device, showing a case where a digital image file having been printed is included; and

FIG. 7 is a view showing a photo-selection screen of the digital image recording control device, showing a case where a digital image file having been printed is included.

### DETAILED DESCRIPTION OF THE INVENTION

Hereinafter, an embodiment of the invention will be described in detail by reference to the drawings.

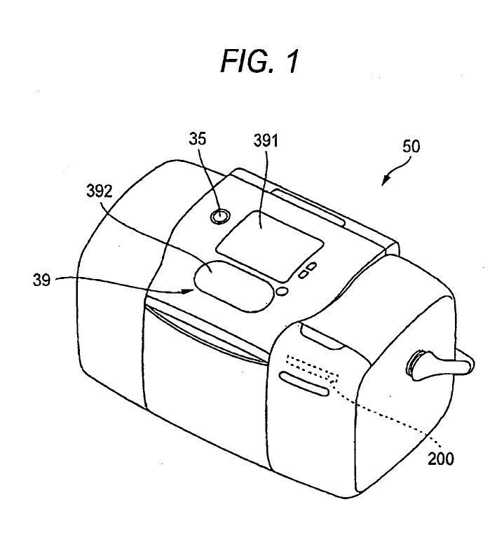

A control panel 39 in an inkjet printer 50 shown in FIG. 1 comprises, in addition to a power switch 35, an operating section 392 by which an operation by a user is input, and a liquid crystal display (hereinafter referred to as an “LCD”) section 391 for graphically displaying information to the user. A controller 100 performs, in accordance with the operation by the user input by way of the operating section 392, control for displaying on the LCD section 391 and control for recording to recording paper (recording medium), on the basis of digital image files stored in a nonvolatile memory card (recording medium) inserted in a card slot 200. A digital image recording control device 40 having a GUI (graphical user interface) function is constituted of the LCD section 391, the operating section 392, and the controller 100. The GUI is a user interface which heavily utilizes graphics for displaying information to the user, and which can be used to perform most basic operations by moving a cursor, to thus provide an instruction in relation to an icon, graphic, or the like, on the display screen.

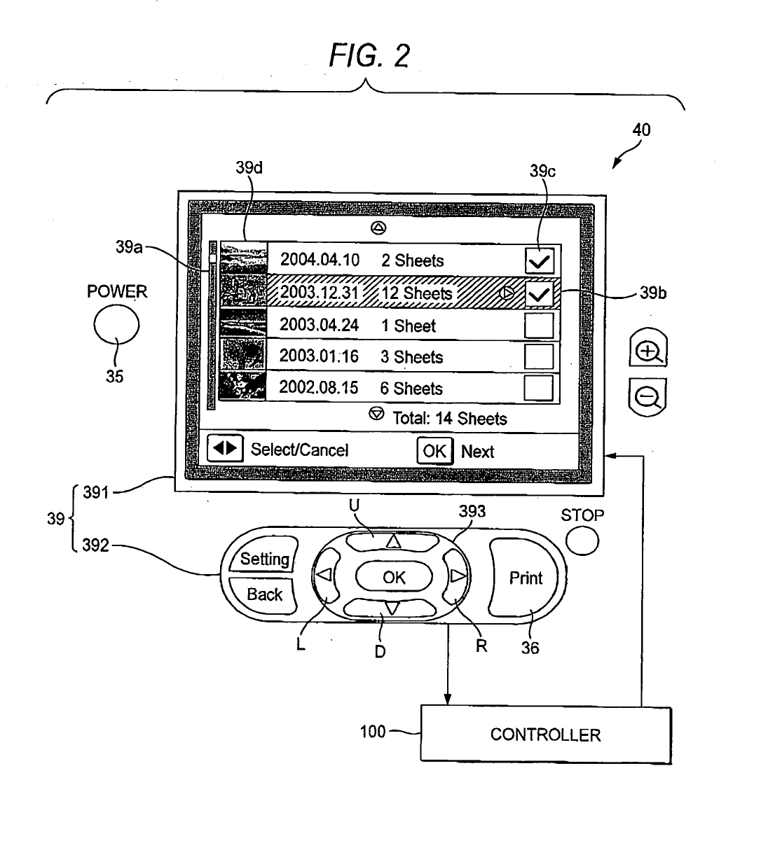

The controller 100 performs grouping of the digital image files stored in the nonvolatile memory card inserted in the card slot 200 in accordance with a predetermined condition; in the embodiment, for each date of photographing described in file headers of the digital image files. Meanwhile, digital image files whose dates of photographing are not described in the file headers are grouped in accordance with dates on which the files have been registered. As shown in FIG. 2, a date-selection screen for displaying a list of all the groups, from which the user can arbitrarily select and designate one or more groups, is displayed on the LCD section 391. On the date-selection screen, a list of date groups (date of photographing the digital images) 39b is displayed; and an arbitrary date group 39b can be designated (selected) by operating an up button U and a down button D of a cursor operating button 393 disposed in the operating section 392, to thus vertically move a cursor.

A date group 39b (2003.12.31) where the cursor rests (cursor-selected) is displayed in such a manner that a display color thereof is changed, and that characters of the date are reversed black and white. When the number of the date groups 39b exceeds the number that can be displayed on the screen (five groups in the embodiment), scrolling can be effected by operating the up button U and the down button D of the cursor operation button 393, thereby vertically moving the cursor, and a scroll bar 39a displays a scroll width, scroll position, and the like. With regard to digital image files photographed by a user himself/herself, in many cases, the user can easily determine what kind of digital image files are included in a group on the basis of a date of photographing. Therefore, when digital image files stored in a nonvolatile memory card, or the like, are grouped in accordance with dates of photographing, a user can easily identify desired digital images.

A display of each of the date groups 39b includes a check box 39c; and, by operating a right button R and a left button L of the cursor operation button 393 with the cursor having been moved to an arbitrary date group 39b, designation/cancellation (select/cancel) of the arbitrary date group 39b can be alternately activated. The lower left of the screen displays information for notifying the user of the above (icons of the right button R and left button L, and texts of “SELECT/CANCEL”). A check mark is displayed in each check box of date groups 39b which are being designated (selected) as shown in the drawing (2004.04.10 and 2003.12.31).

The respective date groups 39b are displayed in the form of a list, to which reduced images 39d are attached. The reduced image 39d is displayed in such a manner that any one of thumbnail images of digital image files belonging to the date group 39b is displayed for each date group 39b. The user can easily identify contents of digital image files in each of the date groups 39b by viewing the reduced image 39b attached to each of the date groups 39b even when having failed in identification of the same of the basis of a group name (the date of photographing the digital images).

Meanwhile, the reduced image 39b may use a thumbnail image of the digital image file whose date of photographing is the latest in each of the date group 39b. With regard to digital image files photographed by the user himself/herself, since, in many cases, a digital image whose date of photographing is the latest is considered to remain in the user's memory most clearly, contents of the digital image file in the date group 39b can be identified easily from the reduced image 39d.

Furthermore, the date-selection screen displays, for each date group 39b, the number of digital image files belonging to the date group 39b, as shown in the drawing (for instance, 2 images for 2004.04.10, and 12 images for 2003.12.31). As a result, a user can eliminate unnecessary operation and wasteful recording in accordance the number of digital image files in each of the date groups 39b, to thus perform effective recording of digital images to recording paper. The total number of digital image files in currently designated (selected) date groups 39b is displayed in the lower side of a display region of the respective date groups 39b (14 images in total).

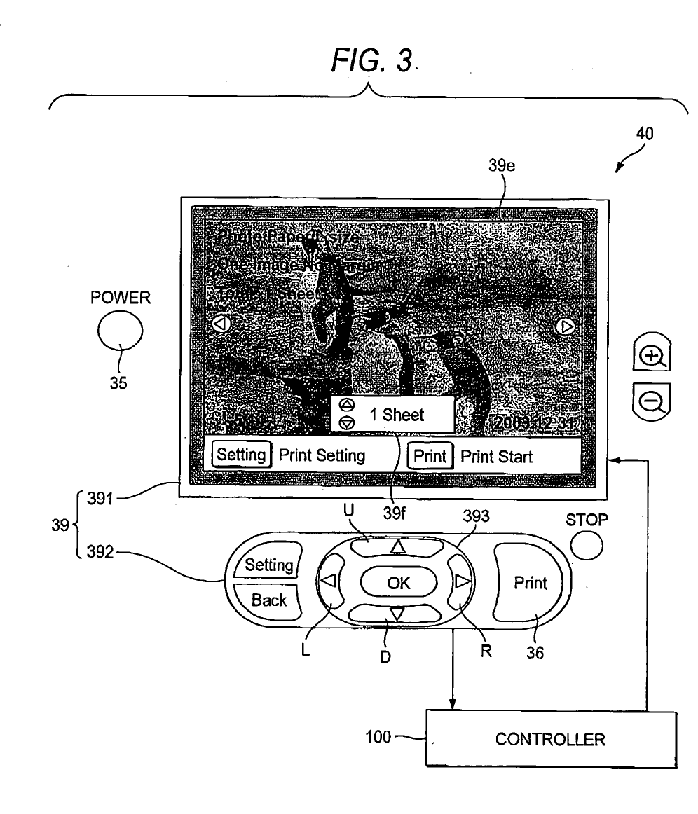

In a case where the LCD section 391 displays the date-selection screen, when an OK button disposed at the center of the cursor operation button 393 is depressed, display on the screen of the LCD section 391 switches (proceeds) to a subsequent screen (photo-selection screen); and when a back button in the operating section 392 is depressed, display on the screen of the LCD section 391 switches (returns) to the previous date-selection screen. In the date-selection screen, the user selects and designates some date groups 39b (causes check boxes 39c to display check marks), which are assumed to include desired image files, from the date groups 39b on the basis of dates of photographing; and depresses the OK button, thereby causing the LCD section 391 to display the photo-selection screen shown in FIG. 3. As a result, a large number of digital image files can be selected by reference to a date of photographing, thereby narrowing down selection to desired digital image files.

In the photo-selection screen, all digital image files 39e in the date groups 39b having been designated by the user in the date-selection screen (check marks are caused to display in the check boxes 39c) are caused to display in full-screen in the LCD section 391 one image at a time, and the user can select and designate desired digital image files while successively viewing the images. By operating the right button R and the left button L of the cursor operation button 393, the digital image 39e which is displayed in full-screen on the LCD section 391 can be caused to change to the next image (by depressing the right button R) or change to the previous image (by depressing the left button L), one image at a time.

Since the digital image (original image) of the digital image files is displayed in substantially full-screen, even in the event of a defect having occurred at the time of photographing, such as being out of focus, or blurred due to camera motion, or the like, is included in the desired digital image, the user can grasp the failure easily and without fail. And, upon grasping thereof, the user can determine whether or not to perform printing on a recording medium. Meanwhile, when a date-selection screen includes none of the date groups 39b designated by the user, all the digital image files within a date group 39b where the cursor rests at the time when the OK button in the operating section 392 is depressed are assumed to be digital images that are to be displayed on the photo-selection screen.

In addition, an indication of the number of sheet to be recorded 39f of the digital images 39e, which are currently displayed on the LCD section 391, is displayed at the lower center of the photo-selection screen. By operating the up button U and the down button D of the cursor operation button 393, the number of sheet to be recorded (to be printed) displayed at the indication of number of sheet to be recorded 39f can be increased (by depressing the up button U) or the same is decreased (by depressing the down button D). When the number of sheet to be recorded is set to “0 sheet,” recording (printing) of the digital image 39e is not performed.

A group name (date of photographing) of the date group 39b, to which the digital image file of the currently full-displayed digital image 39e belongs, is displayed at the lower right of the screen of the photo-selection screen. For instance, when a digital image of a digital image file belonging to a group 39b whose date of photographing is Dec. 31, 2003 is displayed, “2003.12.31” is displayed at the lower right of the screen. In addition, at the lower left of the screen are displayed the total number of digital image files belonging to the date group 39b having been designated in the date-selection screen, and the ordinal number of the currently displayed digital image among the digital image files. For instance, in a case where the total number is 14 and the 5th digital image is displayed in full-screen, “ 5/14” is displayed at the lower right of the screen.

Furthermore, a current setting for print-condition, and the like (photo paper/L-size, the number of image on one sheet, setting for marginless printing, the total number of sheet to be recorded) is displayed at the upper left of the screen. The user can imagine a result of recording while viewing the digital image on the basis of the print-condition setting. The lower side of the screen displays information for notifying the user that a display switches to a print-setting screen (not shown) for performing setting for a recording condition (print setting) by depressing a setting button in the operating section 392 (an icon of the setting button and text reading “PRINT SETTING”). In the print-setting screen, setting for the recording condition (print setting) can be changed. Meanwhile, by the user depressing the setting button in the operating section 392, the print-setting screen can be displayed at any time irrespective of a type of the currently displayed screen.

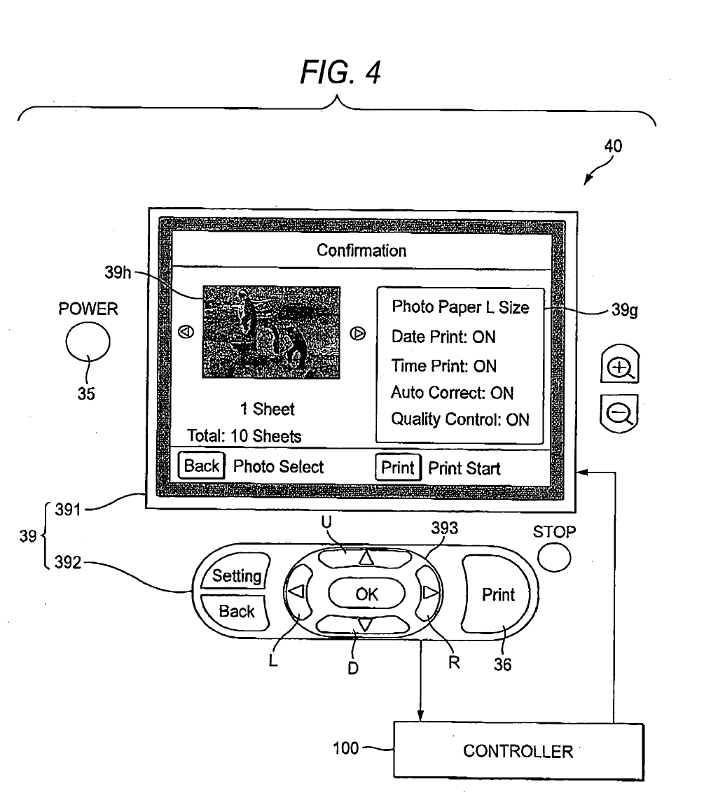

In a situation where the LCD section 391 displays the photo-selection screen, when the OK button in the operating section 392 is depressed, the display on the screen of the LCD section 391 switches to a print-confirmation screen shown in FIG. 4; and when a back button in the operating section 392 is depressed, the display on the screen of the LCD section 391 switches to the photo-selection screen shown in FIG. 2.

In the print-confirmation screen, a type and size of a recording paper (photo paper, L-size), as well as ON/OFF state of date printing, ON/OFF state of time printing, ON/OFF state of automatic correlation, ON/OFF state of picture-quality adjustment, and the like, are displayed in a display region 39g on the right side of the screen. In addition, a digital image, whose number of sheet to be recorded has been designated as one or more in the photo-selection screen, is displayed in a display region 39h on the right side of the screen, thereby enabling confirmation of digital images of the digital files which are to be recorded (printed) while sequentially browsing the same. At the lower left of the screen, the number of sheet to be recorded (one sheet) of the currently displayed image, and the total number of sheet to be recorded (ten sheets) are displayed; whereby the user can easily grasp the number sheets of recording paper on which recording (printing) is to be performed. In a situation where the print-confirmation screen is displayed, when the back button in the operating section 392 is depressed, returning to the photo-selection screen shown in FIG. 3 is effected, thereby enabling re-designation of digital images, changing the number of sheets to be recorded, and the like. The lower side of the screen displays information for notifying the user of the above (an icon of the back button, and text reading “PHOTO SELECT”).

When a print button 36 (a print button to bearing text reading “PRINT”) in the operating section 392 is depressed in a situation where the print-confirmation screen is displayed, recording to recording paper on the basis of the digital images, having been designated in the photo-selection screen, is performed by only the number of sheet to be recorded having been set for each of the designated digital images. The lower side of the screen displays information for notifying the user that recording (printing) is started upon depression of the print button 36 (with an icon of the print button and text reading “PRINT START”).

Meanwhile, the above instruction for printing is also provided in the situation shown in FIG. 3 where the photo-selection screen is displayed; and the lower left of the screen also displays information for notifying the user of the above (the icon of the print button and the text reading “PRINT START”).

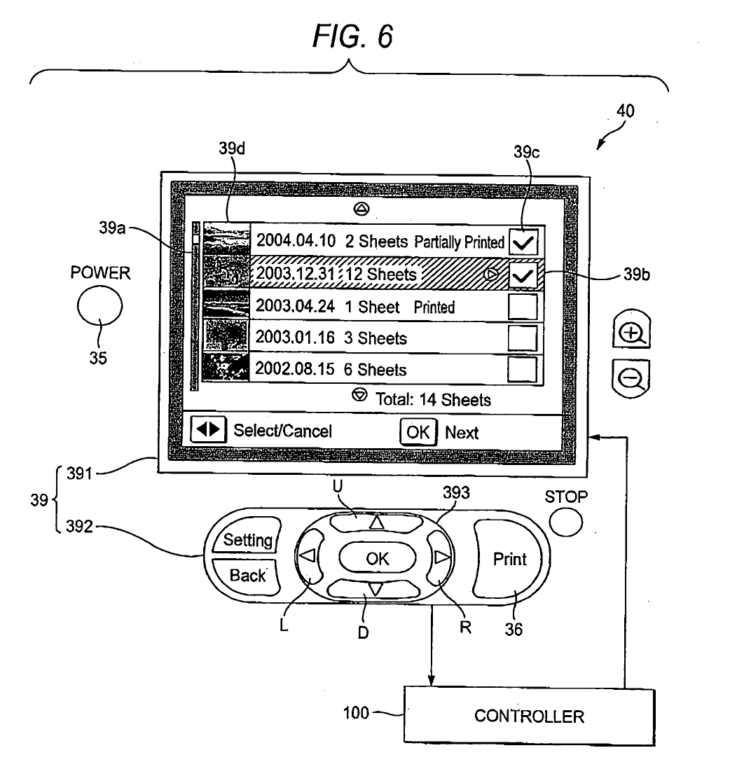

When the print button 36 in the operating section 392 is depressed, display on the LCD section 391 automatically switches to the information screen shown in FIG. 6. The total number of sheet to be recorded and the number of the remaining sheet to be recorded are displayed, whereby the user can easily discern the progress of recording (printing). In addition, when a cancel button in the operating section 392 is depressed during the course of recording (printing), recording (printing) is discontinued, and the screen returns to the display of a state where the print button 36 is depressed. The lower side of the information screen displays information for notifying the user of the above (an icon of the cancel button, and text reading “PRINT STOP”).

In the embodiment, when the print button 36 is depressed in the condition where the date-selection screen in FIG. 2 is displayed on the LCD section 391, all the digital image files within the date groups 39b having been designated by the user in the date-selection screen are designated, and recording (printing) thereof to recording paper is performed. More specifically, when a user designates a desired date group 39b and depresses the print button 36, printing of desired digital images on recording paper can be effected on the basis of date group 39b. At this time, when a plurality of date groups 39b are designated, all the digital images in the plurality of date groups 39b can be recorded (printed) by a single depression of the print button 36.

In addition, when a user designates (selects) none of the date groups 39b in the situation where the date-selection screen in FIG. 2 is displayed on the LCD section 391, all the digital image files in a date group 39b where the cursor rests at the time where the print button 36 in the operating section 392 is depressed are designated, and recording (printing) thereof to recording paper is performed. As a result, the user can alternatively perform recording (printing) for each date group 39b by repeating intuitive operations, such as moving the cursor to a desired date group 39b and depressing the print button 36, thereby performing recording (printing) to recording paper.

When the nonvolatile memory card having been inserted in the card slot 200 (FIG. 1) includes a digital image file which has already been recorded (printed) by the inkjet printer 50, for the purpose of notifying the user thereof, as shown in FIG. 6, a text reading “PREVIOUSLY PRINTED” or “PARTIALLY PRINTED” is displayed for each date group 39b in the date-selection screen. When a date group 39b includes one or more digital image files which have previously been recorded (printed) and at least one digital image file which has not been recorded, the text reading “PARTIALLY PRINTED” is displayed (the date group 39b of 2004.04.10). When all the digital image files included in a date group 39b are digital image files which have previously been recorded (printed), the text reading “PREVIOUSLY PRINTED” is displayed (the date group 39b of 2004.04.24).

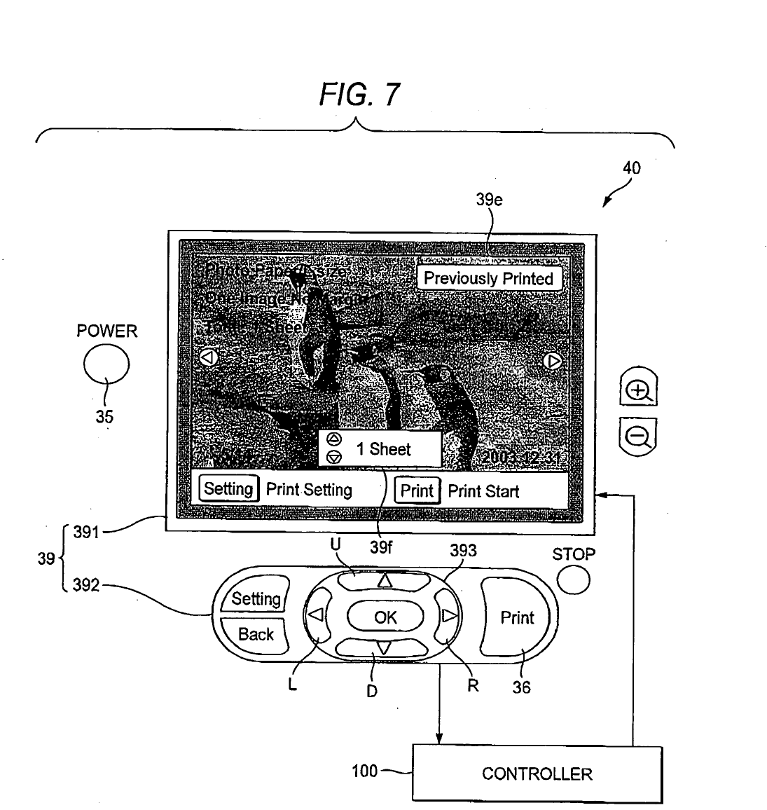

As shown in FIG. 7, when a digital image which is currently displayed in full-screen is of a digital image file which has previously been recorded (printed), text reading “PREVIOUSLY PRINTED” is displayed at the upper right of the screen.

Thus, by facilitating the user's grasping of digital image files which have previously printed, wasteful recording (printing) resulting from erroneous, repetitive recording (printing) of a digital image file having already been recorded on recording paper can be prevented. In addition, when a configuration which allows repetitive recording (printing) of a digital image file having already been printed is employed, needs for extra printing, or the like, can also be satisfied. Meanwhile, notification of whether or not printing has already been performed may be displayed by: recording (printing) history data or the like are written in the nonvolatile memory card in advance; and, upon reference to the history data, a notification of having already been printed is displayed in conjunction with the date-selection screen or the photo-selection screen.

As described above, since digital image files in a recording medium, such as a nonvolatile memory card, are grouped in accordance with a condition, such as a date of photographing, or the like, and digital image files are selected on a per-group basis, to thus be narrowed-down to desired digital image files, the desired digital image files can be easily found, thereby enhancing usability in selection of desired digital images.

In addition, since the desired digital image files are selected and designated while the user sequentially browses, in full-display, the digital image files having been selected and narrowed-down on a per-group basis, even when the desired digital image includes a defect, such as being out of focus, blurred due to camera motion, or the like, having occurred at the time of photographing, a user can easily grasp the failure without fail and determine whether or not to perform printing on recording paper. As a result, probability of wasteful recording (printing), such as recording (printing) performed without noticing a defect having occurred at the time of photographing, can be reduced.

Meanwhile, a touch panel which can be operated by touching a display screen can be employed as the LCD section 391.

As is apparent, the present invention is not limited to the embodiment, and can be modified in various manners within the scope of the invention as set forth in the added claims, and such modifications are also included within the scope of the invention.

What is claimed is:

1. A control device for printing a digital image, comprising:
an operating section, to which an operation of a user is inputted;
a display, which shows information to the user; and
a controller, which causes, in accordance with the operation inputted to the operating section, the display to selectively show:
a first screen image, operable to show a plurality of groups, each of which includes at least one digital image stored in a storage medium and categorized in accordance with a predetermined condition, so that the user designates at least one of the groups through the operating section; and
a second screen image, which shows, in a substantial full-screen manner, the at least one digital image included in the at least one of the groups designated by the user, so that the user browses the at least one digital image one by one to specify the number of sheets to be printed with respect to at least one browsed digital image, through the operating section,
the controller operable to cause a printer to execute a printing operation in accordance with the specification performed in the second screen image when a print instruction is inputted to the operating section.

2. The control device as set forth in claim 1, wherein the controller is operable to cause the printer to execute a predetermined number of printing operation for each of the at least one digital image in the at least one group designated by the user, in a case where the print instruction is inputted when the first screen image is shown in the display.

3. The control device as set forth in claim 1, wherein:
the first screen image includes a cursor which designates one of the groups; and
the controller is operable to cause the printer to execute a predetermined number of printing operation for each of the at least one digital image in the group designated by the cursor, in a case where the print instruction is inputted when the first screen image is shown in the display, and no group is designated by the user through the operating section.

4. The control device as set forth in claim 1, wherein each of the groups is shown with a thumbnail of one digital image included therein.

5. The control device as set forth in claim 4, wherein the one digital image is the latest one in each of the groups.

6. The control device as set forth in claim 1, wherein each of the groups is shown with a total number of the at least one digital image included therein.

7. The control device as set forth in claim 1, wherein the browsed digital image is shown with a name of the designated group which includes the browsed digital image.

8. The control device as set forth in claim 1, wherein the browsed digital image is shown with a printing condition to be effected with respect to the browsed digital image.

9. The control device as set forth in claim 1, wherein each of the groups is shown with information indicating whether at least one digital image included therein has been printed at least once.

10. The control device as set forth in claim 1, wherein the browsed digital image is shown with information indicating whether the browsed digital image has been printed at least once.

11. The control device as set forth in claim 1, wherein the predetermined condition is a date of which the at least one digital image is generated.

12. A printer incorporating the control device as set forth in claim 1, comprising a printing mechanism which is caused to execute the printing operation by the controller of the control device.
